(19) United States
(12) Patent Application Publication
(10) Pub. No.: US 2020/0160455 A1
(43) Pub. Date: May 21, 2020

(54) METHODS AND SYSTEMS OF A MARKETPLACE BLOCKCHAIN-BASED PROTOCOL PLATFORM WITH A TRUST SCORE

(71) Applicants: ASHWARYA PRATAP SINGH, bangalore (IN); ANKUR SENGUPTA, bangalore (IN)

(72) Inventors: ASHWARYA PRATAP SINGH, bangalore (IN); ANKUR SENGUPTA, bangalore (IN)

(21) Appl. No.: 16/458,172

(22) Filed: Jun. 30, 2019

Related U.S. Application Data
(60) Provisional application No. 62/691,921, filed on Jun. 29, 2018.

(51) Int. Cl. G06Q 40/00; G06Q 40/02; G06Q 10/10; G06Q 30/02; G06Q 20/36; G06Q 20/06; G06F 16/27; H04L 29/06

(52) U.S. Cl. CPC G06Q 40/12; G06Q 40/02; G06Q 10/10; G06Q 30/0283; G06Q 2220/00; G06Q 20/0655; G06F 16/27; H04L 63/102; G06Q 20/3672

(57) ABSTRACT

In one aspect, a computerized blockchain-based method comprising the setp of providing a marketplace blockchain-based protocol platform. Tthe marketplace blockchain-based protocol platform comprises a blockchain based distributed computing platform that hosts critical transaction records in a blockchain, and a universal-verified profile module that manages a decentralized trust and identity platform, wherein the universal- verified profile module enables users to create a single, verified profile across all sharing platforms while retaining control of their personal information, a cryptocurrency module that provides and manages a blockchain-based cryptocurrency, a lease/contract module that manages and provides a set of smart contracts;, and an off-blockchain storage.

### CROSS-REFERENCE TO RELATED APPLICATIONS

This application claims priority from U.S. provisional patent application No. 62691921, titled METHODS AND SYSTEMS OF A DECENTRALIZED, MULTI-CRYPTOCURRENCY WALLET APPLICATION and filed on 29 Jun. 2018. This application is hereby incorporated by reference in its entirety.

### BACKGROUND

### 1. Field

This application relates generally to blockchain technology, and more particularly to a system, method and article of manufacture of marketplace blockchain-based protocol platform with a trust score.

### 2. Related Art

The advent of the internet and web-based services have proliferated the growth of sharing and rental platforms worldwide. This has allowed us to share a wide variety of assets; from houses and cars to intangible assets like skills. In sharp contrast to conventional consumption where ownership and access to resources are restricted to their proprietors, these systems propound collaborative consumption. The “sharing economy” refers to the phenomenon of turning unused or underused assets into productive resources. The rise of the sharing phenomena has created new competition across a number of industries, most notably hotels, through Airbnb, and taxis, through ride-sharing services like Uber, Lyft, and Sidecar. Unemployed or underemployed people, too, represent unproductive assets and platforms like TaskRabbit and Mechanical Turk allow such people to monetize their unproductive time by linking them to customers who are willing to pay for their skills for a limited time.

As the internet continues to penetrate every aspect of our lives, sharing platforms will register a rapid growth across the world. Advocates laud the sharing economy as a partial solution to the challenges posed by the ongoing financial and environmental crises, worldwide.

### SUMMARY OF THE INVENTION

In one aspect, a computerized blockchain-based method comprising the step of providing a marketplace blockchain-based protocol platform. The marketplace blockchain-based protocol platform comprises a blockchain based distributed computing platform that hosts critical transaction records in a blockchain, and a universal-verified profile module that manages a decentralized trust and identity platform, wherein the universal- verified profile module enables users to create a single, verified profile across all sharing platforms while retaining control of their personal information, a cryptocurrency module that provides and manages a blockchain-based cryptocurrency, a lease/contract module that manages and provides a set of smart contracts;, and an off-blockchain storage.

### BRIEF DESCRIPTION OF THE DRAWINGS

The present application can be best understood by reference to the following description taken in conjunction with the accompanying figures, in which like parts may be referred to by like numerals.

FIG. 1 illustrates an example peer-to-peer vehicle sharing platform methodology, according to some embodiments.

FIG. 2 illustrates an example process for marketplace blockchain-based protocol, according to some embodiments.

FIG. 3 illustrates another example process for implementing a marketplace blockchain-based protocol, according to some embodiments.

FIG. 4 illustrates another example process for implementing a marketplace blockchain-based protocol, according to some embodiments.

FIG. 5 illustrates an example reward distribution, according to some embodiments.

FIG. 6 illustrates an example table of eligible profiles are grouped in the below slabs, with each slab allocated a share of the total reward pool, according to some embodiments.

FIG. 7 depicts an exemplary computing system that can be configured to perform any one of the processes provided herein.

The Figures described above are a representative set and are not an exhaustive with respect to embodying the invention.

### DESCRIPTION

Disclosed are a system, method, and article of manufacture of a decentralized, multi-cryptocurrency wallet application. The following description is presented to enable a person of ordinary skill in the art to make and use the various embodiments. Descriptions of specific devices, techniques, and applications are provided only as examples. Various modifications to the examples described herein can be readily apparent to those of ordinary skill in the art, and the general principles defined herein may be applied to other examples and applications without departing from the spirit and scope of the various embodiments.

Reference throughout this specification to “one embodiment,” “an embodiment,” “one example,” or similar language means that a particular feature, structure, or characteristic described in connection with the embodiment is included in at least one embodiment of the present invention. Thus, appearances of the phrases “in one embodiment,” “in an embodiment,” and similar language throughout this specification may, but do not necessarily, all refer to the same embodiment.

Furthermore, the described features, structures, or characteristics of the invention may be combined in any suitable manner in one or more embodiments. In the following description, numerous specific details are provided, such as examples of programming, software modules, user selections, network transactions, database queries, database structures, hardware modules, hardware circuits, hardware chips, etc., to provide a thorough understanding of embodiments of the invention. One skilled in the relevant art can recognize, however, that the invention may be practiced without one or more of the specific details, or with other methods, components, materials, and so forth. In other instances, well-known structures, materials, or operations are not shown or described in detail to avoid obscuring aspects of the invention.

The schematic flow chart diagrams included herein are generally set forth as logical flow chart diagrams. As such, the depicted order and labeled steps are indicative of one embodiment of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, and they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

Definitions

Collaborative consumption can be based on the principle of unlocking the value of unused or underutilized asset. It can entail sharing, swapping, trading or renting of goods and services. The customers on the demand side pay for access instead of ownership. The sharing economy can combine an umbrella of the broad spectrum of activities that corroborate collaborative consumption.

Cryptocurrency digital asset designed to work as a medium of exchange that uses strong cryptography to secure financial transactions, control the creation of additional units, and verify the transfer of assets. Cryptocurrency is a kind of digital currency, virtual currency or alternative currency. Cryptocurrencies use decentralized control as opposed to centralized electronic money and central banking systems. The decentralized control of each cryptocurrency works through distributed ledger technology, typically a blockchain, that serves as a public financial transaction database.

ERC20 is a technical standard used for smart contracts on the Ethereum blockchain for implementing tokens. ERC stands for Ethereum Request for Comment, and 20 is the number that was assigned to this request.

Ethereum is an open-source, public, blockchain-based distributed computing platform and operating system featuring smart contract (e.g. scripting) functionality.

Smart contract smart contract is a computer protocol intended to digitally facilitate, verify, or enforce the negotiation or performance of a contract. A smart contract is configured to enable the performance of credible transactions without third parties. A smart contract can provide transactions that are trackable and irreversible.

Example Systems

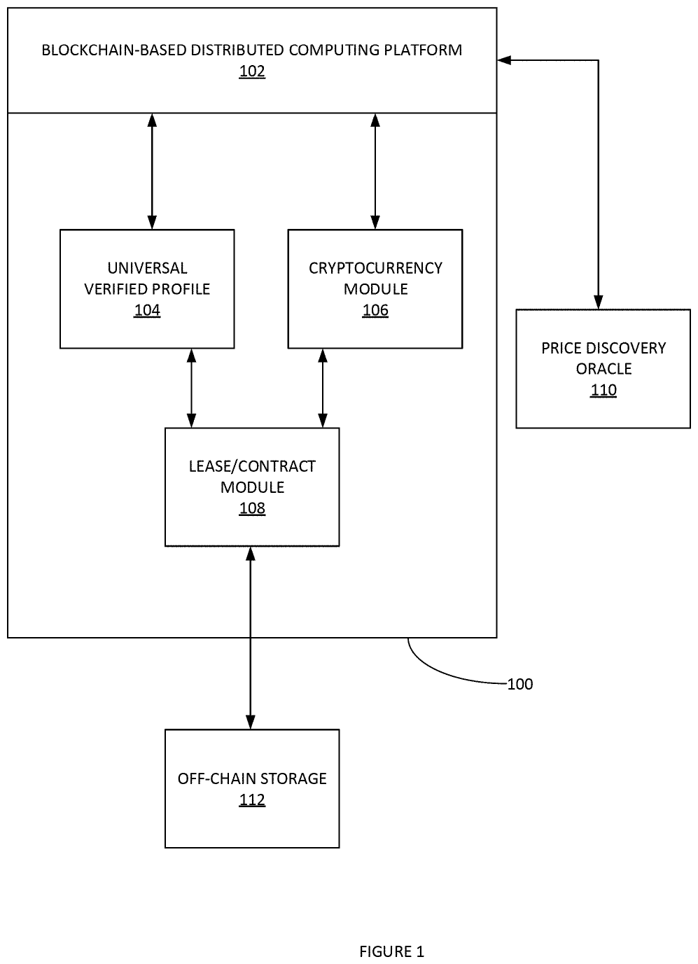

FIG. 1 illustrates an example marketplace blockchain-based protocol platform 100 methodology, according to some embodiments. System 100 can be used to provide and manage a protocol where sharing the value of goods and services can be as easy as sharing information on the World Wide Web. System 100 can utilize blockchain technology as provide infra. System 100 can be used as a basis for a sharing economy with a lower error rate, less resulting risks, lower capital requirements and reduced vulnerability to cyber-attacks.

System 100 can implement an example marketplace blockchain-based protocol as now discussed. The blockchain-based protocol can include four modules which can provide basic marketplace functionalities. In one example, the marketplace blockchain-based protocol platform 100 can implement a peer-to-peer vehicle sharing platform.

The four modules include, inter alia, a cryptocurrency module 106. In one example, cryptocurrency module 106 can generate and manage a cryptocurrency that pegged to the United States Dollar. Lease/Contract module 108 can provide a low-cost and stable global payment mechanism.

A Lease/Contract module 108 is provided. Lease/Contract module 108 can be configured to manage and provide various smart contracts. For example, Lease/Contract module 108 can provide an Ethereum-base smart contract to reduce the marginal cost of executing sharing transactions.

A universal-verified profile module 104. The universal-verified profile module 104 can manage the decentralized trust and identity platform. The universal-verified profile module 104 can enable users to create a single, verified profile across all sharing platforms while retaining control of their personal information. Additional information is provided infra.

Pricing suggestion oracle 110 can enable asset owners and online sharing platforms to determine the price of an asset based on its location.

Through the use of a smart contract, all sharing transactions can be recorded on-chain. The open nature of a blockchain's transaction records can enable universal-verified profile module 104 and pricing suggestion oracle 110 to exist. Universal-verified profile module 104 can be able to use the shared transaction history to rate the trustworthiness of the participants. This same open nature can enable pricing suggestion oracle 110 to provide price discovery through a holistic analysis of all transactions across the protocol.

In one example, blockchain based distributed computing platform 102 can include an Ethereum blockchain. Blockchain based distributed computing platform 102 can as the backbone of the marketplace blockchain-based protocol to host critical transaction records. Blockchain based distributed computing platform 102 can host all contract metadata (e.g. asset images, descriptions, etc.) off-chain storage such as the Interplanetary File System (IPFS) (e.g. see off-chain storage 112, etc.). The transaction record can contain an IPFS hash to reference the relevant data.

Universal-verified profile module 104 provide and manage a decentralized directory of peers on the blockchain. Peers can be able to create a universal-verified profile module 104 profile through a smart wallet. As used, herein, the smart wallet can be a digital wallet. The digital wallet can be an electronic device or online service that enables an individual to make electronic transactions. This can include purchasing items on-line with a computer or using a smartphone to purchase something at a store. A cryptocurrency wallet is a digital wallet where private keys are stored for cryptocurrencies like bitcoin.

Every profile in the directory will represent a peer on the marketplace blockchain-based protocol and can be assigned a base decentralized trust score by default. universal-verified profile module 104 can significantly reduce the cost of operations such as customer KYC and onboarding through a robust and transparent digital identity platform built on shared customer data. Using the encrypted storage featured by blockchain will make protecting user data drastically easier. Universal-verified profile module 104 can enable the sharing economy to build a network of trusted lessors and lessees who can be able to access any sharing service through a single identity profile.

System 100 can include an open API that enables platforms to seamlessly update the user's record on the directory directly through their existing framework. This can enable for the universal-verified profile module 104 provide and manage a directory. The directory can be updated independently for fiat and other cryptocurrencies. For the purposes of peer-to-peer transactions, the directory will also be updated through the smart wallet. A peer's universal-verified profile module 104 profile will comprise of the below data points, inter alia: name, profile image, mobile number, email-ID, social media links, a decentralized trust score, etc.

The email and social media profiles can link the peer's identity on the universal-verified profile module 104 system with their respective decentralized trust score. This can incentivize peers to act appropriately as their activity on sharing platforms can reflect on their other profiles.

The decentralized trust score for a peer can be calculated on the basis of inputs recorded over past transactions. Each user can start with a default score which can increase or decrease depending on peer actions during a lease contract. The algorithm can account for whether the peer had acted as a lessor or a lessee during a transaction. Accordingly, there can be two sets of metrics used to calculate the decentralized trust score.

In one example, the marketplace blockchain-based protocol platform 100 for leasing assets. In this example, an asset class being rented or leased. Depending on the type of asset they share, a lessor assumes different amounts of liabilities. Expensive assets which can be easily damaged score higher. For example, even though a house may cost more, a car is more likely to incur a higher amount of damage due to bad driving. In terms of our algorithm, this value can be expressed as a multiplier.

The marketplace blockchain-based protocol platform 100 can implement a peer-to-peer vehicle sharing platform can provide a lessee's rating of lessor. This can be based on peer feedback and can constitute an important part of the decentralized trust score. A lessor can receive higher ratings if they share assets as promised, on time and are responsive to claims and feedback.

Asset class being leased can, in a manner similar to the lessor, provide that the lessee' score also varies on the type of asset they can be leasing. Using the same example as above, when a peer can lease a car they can also assume a higher responsibility. Consequently, lessees will receive a higher multiplier for the desired behavior.

Transaction amount and frequency can also be considered. The decentralized trust score can take into consideration the amount of value that a lessee has will add to the overall marketplace blockchain-based protocol. This value can be calculated as a weighted average of the amount and frequency of their transactions.

Dues can be considered as well. In the course of rental transactions situations can arise that cause a change in the terms of a contract. A peer may be delayed in returning a car or may require a house for longer than the lease. In such cases, the additional cost can be counted as a due. Peers will be expected to clear any such dues within an acceptable time frame. Any unpaid dues can be weighted against the value of the asset to calculate the penalty to a peer's score.

The lessor rating can be considered. In addition to the above factors, a lessee also receives a rating from the lessor. Peers who complete transactions within the predetermined time frame without damaging the assets can be more desirable and will be rated higher.

It is noted that, each sharing industry, such as car-sharing, ridesharing, accommodation-sharing, etc., uses different metrics and algorithms to define a peer's trustworthiness. To accommodate the various metrics used by each industry, participating platforms can be able to choose the algorithm best suited for them. We can only provide a default algorithm. Platforms can be able to publish a user's score to universal-verified profile module 104 through the open APIs.

Universal-verified profile module 104 profiles can support verification through a KYC (know your client/customer) process. Verifications can be processed through trusted verification agents. Peers can share proof of their identity with these agents through an encrypted channel. Once the peer's identity can be verified, the agent can add an attestation of the same to the peer's profile. The documents can reside privately with the peer on their personal wallet. The attestation on their profile can prove the validity of their identity. The cost of this one-time verification can be paid by the peer to the agent.

Thus, the decentralized trust score can be a quantitative representation of the behavior of a peer on the marketplace blockchain-based protocol.

Through the use of a smart contract, all sharing transactions can be recorded on-chain. The open nature of a blockchain's transaction records can enable universal-verified profile module 104 and pricing suggestion oracle 110 to exist. Universal-verified profile module 104 can be able to use the shared transaction history to rate the trustworthiness of the participants. This same open nature can enable pricing suggestion oracle 110 to provide price discovery through a holistic analysis of various transactions across the marketplace blockchain-based protocol. We can use the Ethereum blockchain as the backbone of our marketplace blockchain-based protocol to host critical transaction records. Due to the high cost of storing data on-chain, we can host all contract metadata (e.g. asset images, descriptions, etc.) off-chain storage such as the Interplanetary File System (IPFS). The transaction record can contain an IPFS hash to reference the relevant data.

It is noted that system 100 can include an off-chain trust ledger (e.g. universal-verified profile module 104) and/or a pricing oracle pricing suggestion oracle 110. The universal-verified profile module 104 is an off-chain ledger of peers on the system 100. A peer can create a universal-verified profile module 104 profile through the smart wallet. Every profile in the directory represents a peer on system 100 network and is assigned a base trust score by default. An open API can enable platforms to seamlessly update the peer's record on the directory directly through their existing framework. A peer's universal-verified profile module 104 profile can comprise of at least four data points (e.g. name, email-id, social media links, trust score, etc.). The email and social media profiles link the peer's identity on the universal-verified profile module 104 system with their respective trust score. This may incentivize peers to act appropriately as their activity on sharing platforms can reflect on their respective universal-verified profile module 104 profiles. Owing to the generic nature of the system, the universal-verified profile module 104 can be horizontally scalable. The trust score for a peer is calculated on the basis of inputs recorded over past transactions. Each user can start with a default score which can increase or decrease depending on peer actions during a lease contract. The algorithm accounts whether the peer acted as a lessor or a lessee during a transaction.

Accordingly, there are more than one set of metrics (e.g. two sets) that can be used to calculate the trust score. (For example, the process can take into consideration the feedback from not just two (2) parties to calculate the trust score). Lessee's rating of lessor can be used. Peer feedback constitutes a part of the trust score. A lessor receives higher ratings when they share assets as promised, on time and is responsive to claims and feedback. Compliments can also be used. At the completion of transactions, both parties can be able to share compliments based on their experience. Any compliments can be publicly linked to a profile and enables others to ascertain the quality of the peer. With respect to the Lessee a transaction amount and frequency score can be used. The score can take into consideration the amount of value that a lessee has added to the overall network. This value can be calculated as a weighted average of the amount and frequency of their transactions. A lessee may also receive compliments on their behavior during a transaction. These compliments can be available to be viewed publicly. In the course of rental transactions, situations may arise that cause a change in the terms of a contract. A peer may be delayed in returning a car or may require a house for longer than the lease. In such cases, the additional cost can be counted as a due. Peers are expected to clear any such dues within an acceptable time frame. Any unpaid dues can be weighed against the value of the asset to calculate the penalty to a peer's score. A Lessor rating can be used. In addition to the above factors, a lessee also receives a rating from the lessor. Peers who complete transactions within the predetermined time frame without damaging the assets are more desirable and can be rated higher. Thus, the trust score is a quantitative representation of the behavior of a peer on the network of system 100.

The universal-verified profile module 104 can support profile verification. Verifications can be processed through trusted verification agents. Peers can share proof of their identity with these agents through an encrypted channel. Once the peer's identity can be verified, the agent can add an attestation of the same to the peer's profile. The documents can reside privately with the peer on their personal wallet. The attestation on their profile can prove the validity of their identity. The cost of this one-time verification can be paid by the peer to the agent.

An example of accessing universal-verified profile module 104 is now provided. It is noted that the smart wallet can function as an interface to the universal-verified profile module 104. Peers can use the wallet to create, manage and access their universal-verified profile module 104 profiles. On the completion of a lease, peers can post compliments and ratings describing their experience. Ratings and compliments provide an open platform to ascertain the trustworthiness of peers on the network.

A reward pool can also be provided and managed. The reward pool serves two purposes: to incentivize the adoption of marketplace blockchain-based protocol and to create a trusted ecosystem. The pool can be generated every twenty-four (24) hours in some example. Newly created cryptocurrency can be disbursed to peers based on the transaction volume and the amount locked by them over twenty-four (24) hours.

Example Methods

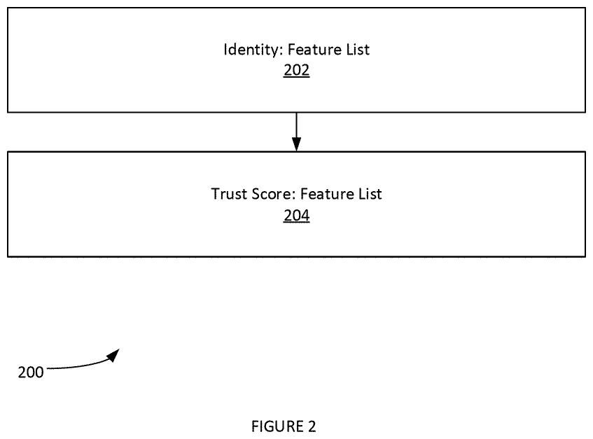

FIG. 2 illustrates an example process 200 for marketplace blockchain-based protocol, according to some embodiments. Process 200 can provide and manage a decentralized trust and identity platform that enables users to create a single verified profile across all sharing platforms. The profile can include a trust score calculated on the basis of inputs recorded over past transactions. The actors of process 200 can include the following. Individual users; lessees (e.g. create and use their marketplace blockchain-based protocol profile to rent assets; lessors create and use their marketplace blockchain-based protocol profiles to list their assets; sharing service providers who would list assets on the platform; a cryptocurrency provider; KYC / AML provider(s); etc. In step 202, process 200 can verify entity identity. In step 204, process 200 can provide/manage a decentralized trust score.

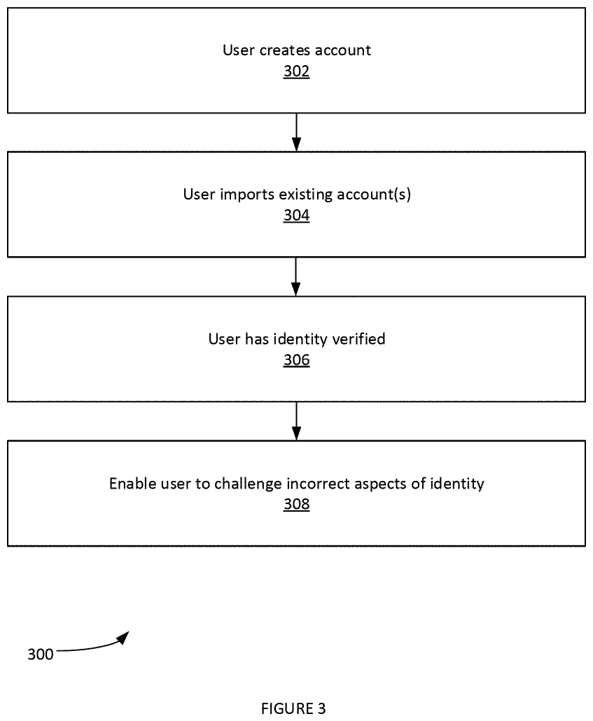

FIG. 2 illustrates an example process 200 for marketplace blockchain-based protocol, according to some embodiments. FIG. 3 illustrates another example process 300 for implementing a marketplace blockchain-based protocol, according to some embodiments. In step 302, process 300 can enable users to create an account. In step 304, process 300 can enable a user to import existing account(s). In step 306, process 300 can verify the user's identity. In step 308, process 300 can enable user to challenge incorrect aspects of identity.

An example of process 300 is now provided. Users can create an account. The account is issued against an address in a blockchain system. Once created, the account can be assigned a default score. Users can import an already existing account. It can also be assigned the default score. User can have their identity verified by providing the relevant information. The verification status can be reflected in the user's profile. Users can have their identity verified by providing their personal identification documents to authorized KYC/AML providers. The KYC/AML provider validates the user's identity and sends a signal to universal-verified profile module 104, approving or rejecting the same. For example, a user can receive an SMS with a code and user input it to verify. In another example, a user receives an email with a code. In another example, a user can connect a SNS accounts via an API (e.g. using Oauth, etc.) and import friend graph data to universal-verified profile module 104. The user can challenge one's identity if he suspect one's identity information is wrong. An AML/KYC provider ask the claimed user to re-verify their identity. Universal-verified profile module 104 have some incentives to challenge (and prevent abusing challenges).

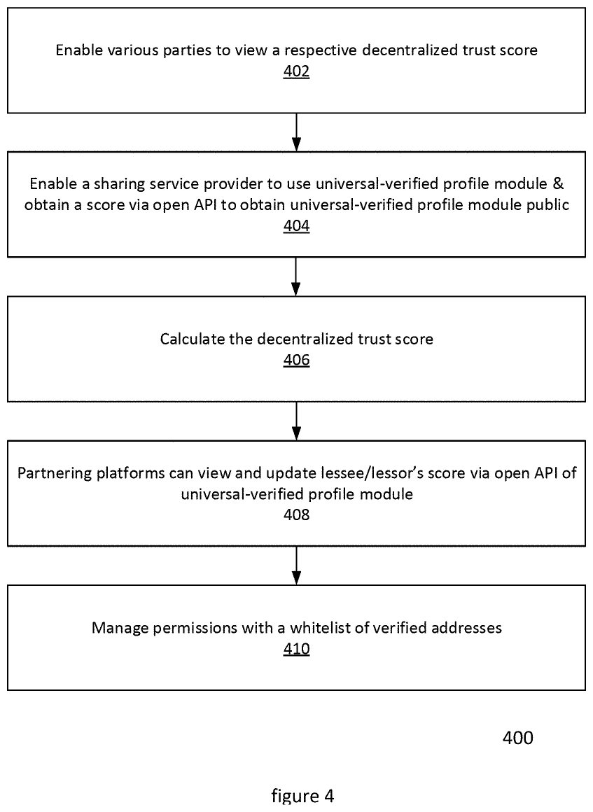

FIG. 4 illustrates another example process 400 for implementing a marketplace blockchain-based protocol, according to some embodiments. In step 402, process 400 can enable various parties to view a respective decentralized trust score. For example, lessors can view a lessee's trust score in their client application. Lessees can view their trust score history. Lessors can offer different prices for rentals according to the lessees' trust score. In step 404, process 400 can enable a sharing service provider to use universal-verified profile module 104 score via open API to get the universal-verified profile module 104 public score. In step 406, process 400 can calculate the decentralized trust score. The universal-verified profile module 104 scores are calculated with the transaction data stored in the blockchain and rating data of lessors or lessees. This can be from, inter alfa: the user's transaction history; rental data from completed; etc. Lease contracts can be implemented. Partnering platforms can fetch transaction data with open API of universal-verified profile module 104. In step 408, the partnering platforms can view and update lessee/lessor's score via open API of universal-verified profile module 104. Only authorized third parties can update lessor/lessee's trust score. In step 410, process 400 can manage permissions with a whitelist of verified addresses. Process 400 can provide additional future services based on universal-verified profile module 104 score. Process 400 can provide/manage financial services (e.g. micro-lending; special offers; lending services for the lessors (for supplying more assets on the platform); etc.).

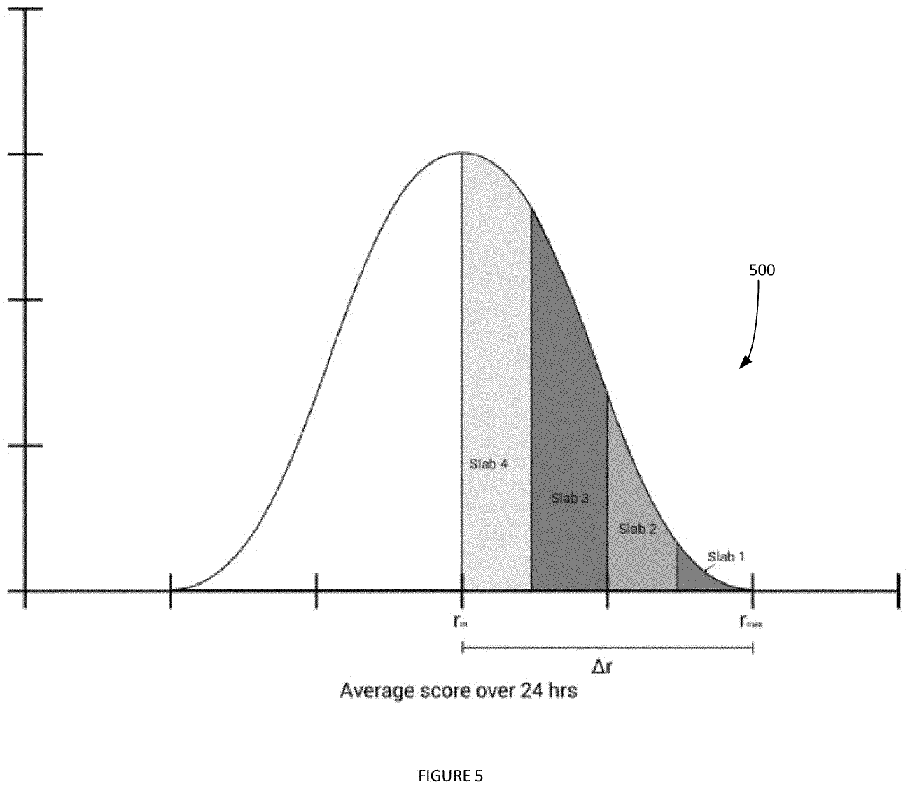

FIG. 5 illustrates an example reward distribution 500, according to some embodiments. Reward distribution 500 shows an example daily-reward pool distributed amongst peers who have active universal-verified profile module 104 profiles. The share an individual receives is based on their behavior on the network over a twenty-four-hour (24 hrs.) period.

Assuming the average rating for an individual user in a twenty-four-hour cycle for n transactions as

r=AVERAGE(r1, r2, r3, . . . , rn)

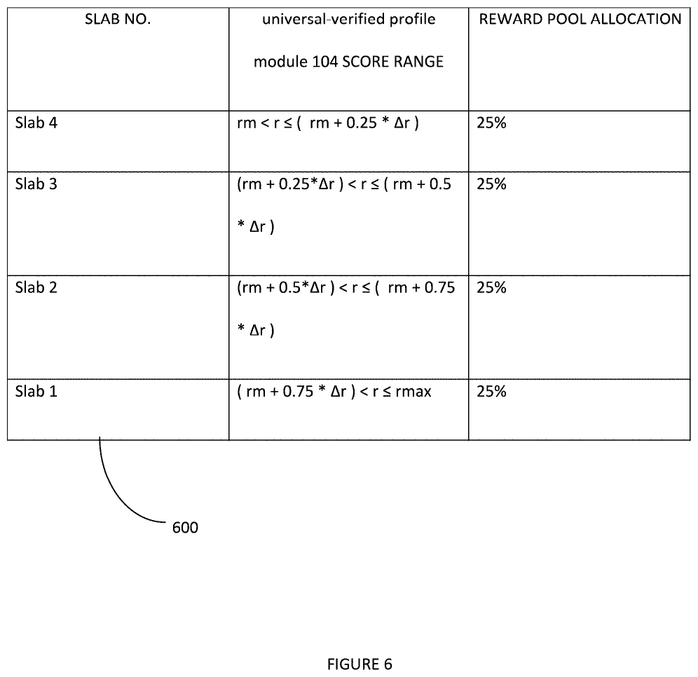

The above graph plots the average score (r) of every individual user over the twenty-four-hour cycle, with rm as the median value. Only individuals whose average rating is above the median rating (rm) for that cycle, can be eligible for the distribution. Each distribution is divided into four slabs. If rmax is the highest daily average score obtained by an eligible profile, the slab size is measured as 0.25*Δr, where Δr=(rmax−rm). FIG. 6 illustrates an example table 600 of eligible profiles are grouped in the below slabs, with each slab allocated a share of the total reward pool, according to some embodiments.

An individual is assigned to a group based on their average rating over the previous twenty-four (24) hours. Of the total share allocated to each slab, an individual receives a share proportional to their daily transaction volume within that slab. An individual's share is calculated as:

(tx/tt)*nr

tx: the individual's unique transaction volume over the previous twenty-four (24) hours.

tt: the total unique transaction volume of all individuals within that slab

nr: the number of RENTALCOINS allocated to the individual's slab.

Additional Systems and Architecture

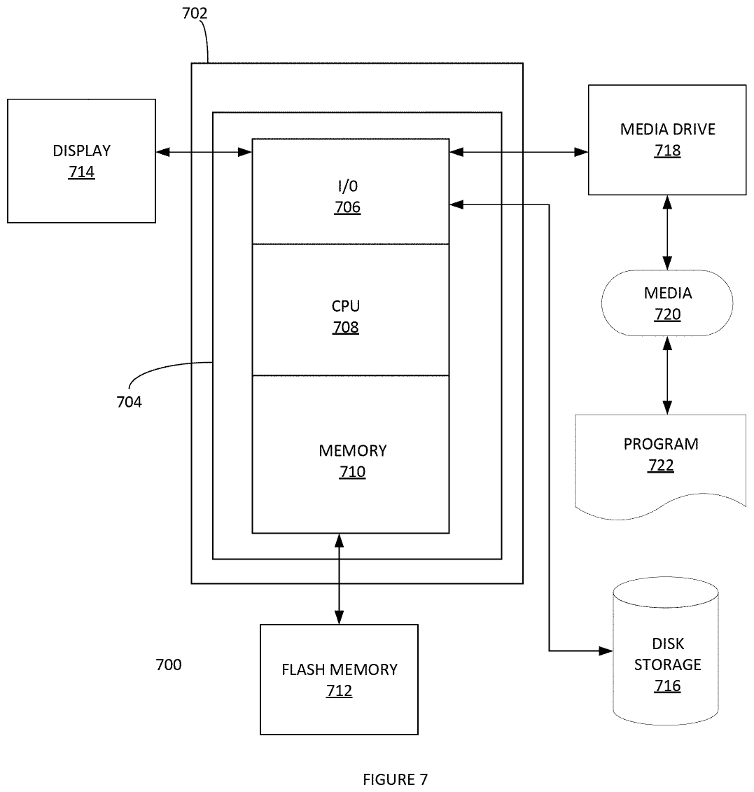

FIG. 7 depicts an exemplary computing system 700 that can be configured to perform any one of the processes provided herein. In this context, computing system 700 may include, for example, a processor, memory, storage, and I/O devices (e.g., monitor, keyboard, disk drive, Internet connection, etc.). However, computing system 700 may include circuitry or other specialized hardware for carrying out some or all aspects of the processes. In some operational settings, computing system 700 may be configured as a system that includes one or more units, each of which is configured to carry out some aspects of the processes either in software, hardware, or some combination thereof.

FIG. 7 depicts computing system 700 with a number of components that may be used to perform any of the processes described herein. The main system 702 includes a motherboard 704 having an I/O section 706, one or more central processing units (CPU) 708, and a memory section 710, which may have a flash memory card 712 related to it. The I/O section 706 can be connected to a display 714, a keyboard and/or other user input (not shown), a disk storage unit 716, and a media drive unit 718. The media drive unit 718 can read/write a computer-readable medium 720, which can contain programs 722 and/or data. Computing system 700 can include a web browser. Moreover, it is noted that computing system 700 can be configured to include additional systems in order to fulfill various functionalities. Computing system 700 can communicate with other computing devices based on various computer communication protocols such a Wi-Fi, Bluetooth® (and/or other standards for exchanging data over short distances includes those using short-wavelength radio transmissions), USB, Ethernet, cellular, an ultrasonic local area communication protocol, etc.

### CONCLUSION

Although the present embodiments have been described with reference to specific example embodiments, various modifications and changes can be made to these embodiments without departing from the broader spirit and scope of the various embodiments. For example, the various devices, modules, etc. described herein can be enabled and operated using hardware circuitry, firmware, software or any combination of hardware, firmware, and software (e.g., embodied in a machine-readable medium).

In addition, it will be appreciated that the various operations, processes, and methods disclosed herein can be embodied in a machine-readable medium and/or a machine accessible medium compatible with a data processing system (e.g., a computer system), and can be performed in any order (e.g., including using means for achieving the various operations). Accordingly, the specification and drawings are to be regarded in an illustrative rather than a restrictive sense. In some embodiments, the machine-readable medium can be a non-transitory form of machine-readable medium.

What is claimed as new and desired to be protected by Letters Patent of the United States is:

1. A computerized blockchain-based method comprising:
providing a marketplace blockchain-based protocol platform;
wherein the marketplace blockchain-based protocol platform comprises:
a blockchain based distributed computing platform that hosts critical transaction records in a blockchain, and
a universal-verified profile module that manages a decentralized trust and identity platform, wherein the universal- verified profile module enables users to create a single, verified profile across all sharing platforms while retaining control of their personal information,
a cryptocurrency module that provides and manages a blockchain-based cryptocurrency,
a lease/contract module that manages and provides a set of smart contracts; and
an off-blockchain storage.

2. The method of claim 1, wherein the blockchain based distributed computing platform hosts all contract metadata.

3. The method of claim 2, wherein the contract metadata comprises an asset images and an asset description.

4. The method of claim 3, wherein the off-blockchain storage comprises an Interplanetary File System (IPFS).

5. The method of claim 4, wherein the lease/contract module that manages and provides an Ethereum-base smart contract.

6. The method of claim 5 further comprising:
a pricing suggestion oracle module configured to enable asset owners and online sharing platforms to determine a price of an asset based.

7. The method of claim 6, wherein the pricing suggestion oracle module configured to enable asset owners and online sharing platforms to determine a price of an asset based on a location of the asset.

8. The method of claim 7, wherein the universal-verified profile module provides and manages a decentralized directory of peers on the blockchain.

9. The method of claim 8 further comprising:
providing a decentralized trust and identity platform that enables users to create a single verified profile across all sharing platforms.

10. The method of claim 9, wherein the profile includes a trust score calculated on the basis of inputs recorded over past transactions.
